(19) United States
(12) Patent Application Publication
(10) Pub. No.: US 2013/0250056 A1
(43) Pub. Date: Sep. 26, 2013

(54) MULTIVIEW 3D COMPRESSION FORMAT AND ALGORITHMS

(71) Applicants: Alain Fogel, Zorneding (DE); Marc Pollefeys, Zurich (CH)

(72) Inventors: Alain Fogel, Zorneding (DE); Marc Pollefeys, Zurich (CH)

(73) Assignee: NOMAD3D SAS, Nice (FR)

(21) Appl. No.: 13/824,395

(22) PCT Filed: Oct. 6, 2011
(86) PCT No.: PCT/IL11/00792

§ 371 Date: Mar. 18, 2013

Related U.S. Application Data
(60) Provisional application No. 61/390,291, filed on Oct. 6, 2010.
(60) Provisional application No. 61/509,581, filed on Jul. 20, 2011.

(51) Int. Cl. H04N 13/00

(52) U.S. Cl. CPC H04N 13/0048
USPC 348/43

(57) ABSTRACT

An LRO format encoder provides images for three-dimensional (3D) viewing, that are at least the quality of images provided by conventional encoding techniques using equivalent bandwidth, with encoding and decoding requiring less power than conventional formats. The LRO format facilitates encoding of multiple images using an innovative multiview low energy (MLE) CODEC that reduces the power consumption requirements of encoding and decoding 3D content, as compared to conventional techniques. A significant feature of the MLE CODEC is that a decoded view from a lower processing level is used for one of the components of the LRO format for at least one higher processing level. Thus, some components of the LRO level for a higher view can be derived from processing of lower views, and not all the components of the higher view need to be transmitted as part of the data for the MLE CODEC

### CROSS-REFERENCE TO RELATED APPLICATIONS

This application claims the benefit of provisional patent application (PPA) Ser. No. 61/390,291 filed Oct. 6, 2010 (attorney file 4221/6), and PPA Ser. No. 61/509,581 filed Jul. 20, 2011 (attorney file 4221/8) by Alain Fogel, which are incorporated by reference.

### FIELD OF THE INVENTION

The present embodiment generally relates to the field of computer vision and graphics, and in particular, it concerns a system and format for three-dimensional (3D) encoding and rendering of multiple views.

### BACKGROUND OF THE INVENTION

3D Imaging Technology can be described as the next revolution in modern camera and video technology. Stereo 3D (S3D) is produced by displaying two views, one for each eye, the LEFT and RIGHT views. The main markets for S3D are similar as for 2D: television (TV), cinema, mobile, and cameras. S3D is already being marketed in TV sets, as many LCD TV sets are provided with S3D capability using 3D glasses. 3D Smartphones and tablets are potentially huge markets, due to the phenomenal growth and development of the mobile market. Several 3D handsets and tablets are currently available (e.g., Hitachi, Samsung, Sharp, HTC, and LG currently have products on the market). In all these markets, 2D and 3D digital video content must be stored and delivered via limited bandwidth communication channels or devices. Hence encoding/decoding by CODECs is required to compress the content and satisfy bandwidth limitations. 2D CODECs such as H.264 have significant computing requirements resulting in significant power consumption. While much more critical for battery-powered devices such as mobile devices, power consumption is also a consideration in TV sets and set top boxes (STBs) because of regulatory energy constraints. For S3D CODECs, the problem is much worse: in a brute force approach, the power consumption and the bandwidth are doubled. Hence, any implementation of S3D requires sophisticated algorithms that minimize bandwidth and power consumption. These two requirements usually have opposite effects, since the more sophisticated the algorithms are to limit bandwidth requirement, the more complex is the implementing software/hardware, and the higher the power consumption to implement the algorithm.

The current algorithmic technology that is recommended by the MPEG forum is an extension of H.264/MPEG4 and is called H.264/MPG4-MVC. This algorithm has the advantage of keeping the bandwidth requirement to a reasonable level. However, the power consumption on a mobile device for a typical broadcast video is multiplied by a factor close to 2. Another algorithm technology has been developed by Dolby Laboratories, Inc. called 3D Full-Resolution that includes a layer on top of H.264. This layer is an enhancement for Side by Side 3D HALF HD, enabling 3D FULL HD on set top boxes (STBs). Similar to H.264/MPEG4-MVC, the power consumption when using this additional layer is high, as compared to two-dimensional (2D) viewing.

Multiview 3D is the next step of S3D. With a multiview 3D TV, the viewer will be able to see multiple, different views of a scene. For example, different views of a football match can be seen, by the viewer moving himself and/or selecting the 3D view that the viewer wants to see, just like going around a hologram or turning a hologram in your hand. The same use case applies to tablets with the viewer selecting a desired view by tilting the tablet. Multiview 3D technology with no glasses exists already for specific markets (e.g. advertisement). Currently, the available screen sets are impressive but very expensive as compared to the cost of a non-multiview screen. As such, currently available screen sets do not fit the consumer TV market yet. The LCD sets are typically based on lenticular displays and typically exhibit 8 to 10 views. Today, the resolution of each view is equal to the screen resolution divided by the number of views. Projections for this market are that this limitation on the resolution of each view will be resolved in the future, and that each view will have full HD resolution. In a full resolution multiview 3D TV set or tablet, the computing power and the power consumption for visualizing for example 8 views coded with H.264-MVC, is the power required by a single view multiplied by the number of views (in this case 8) compared to a 2D view. In other words, an 8 view multiview 3D TV set consumes about 8 times as much power as a single view 3D TV set. The power consumption requirements of multiview 3D TV are a challenge for decoding chips and for energy saving regulations.

There is therefore a need for methods and systems for encoding 3D content with the purpose of reducing the power consumption, in particular at the decoder, as compared to conventional techniques.

### SUMMARY

According to the teachings of the present embodiment there is provided a method for encoding data including the steps of: receiving a first set of data; receiving a second set of data; generating a first view, a second view, and associated generating-vectors; wherein the first and second views are generated by combining the first and second sets of data, such that the first view contains information associated with elements of the first set of data, the second view contains information associated with elements of the second set of data other than elements of the second set of data that are in common with corresponding elements of the first set of data, and the associated generating-vectors indicate operations to be performed on the elements of the first and second views to recover the first and second sets of data.

In an optional embodiment, the first view is the first set of data. In another optional embodiment, the first view includes elements that are common to the first and second sets of data. In another optional embodiment, the second view only contains information associated with elements of the second set of data other than elements of the second set of data that are in common with corresponding elements of the first set of data. In another optional embodiment, the second view contains additional information, the additional information other than information only associated with elements of the second set of data other than elements of the second set of data that are in common with corresponding elements of the first set of data. In another optional embodiment, the second view includes elements of the first and second sets of data that are only in the second set of data.

In an optional embodiment, the first set of data is a first two-dimensional (2D) image of a scene from a first viewing angle, and the second set of data is a second 2D image of the scene from a second viewing angle.

In an optional embodiment, the data is in H.264 format. In another optional embodiment, the data is in MPEG4 format.

In an optional embodiment, the method of claim 1 further includes the step of: storing the first view, the second view, and the associated generating-vectors in association with each other.

According to the teachings of the present embodiment there is provided a method for decoding data including the steps of: a first view and a second view, the first and second views containing information associated with elements of a first set of data and a second set of data such that the first view contains information associated with elements of the first set of data, and the second view contains information associated with elements of the second set of data other than elements of the second set of data that are in common with corresponding elements of the first set of data; receiving generating-vectors associated with the first and second views, the generating-vectors indicating operations to be performed on elements of the first and second views to generate the first and second set of data; and generating, using the first view, the second view, and the generating-vectors, at least the first set of data.

In an optional embodiment, the method includes the step of generating, using the first view, the second view, and the generating-vectors, the second set of data.

According to the teachings of the present embodiment there is provided a system for encoding data including: a data-receiving module configured to receive at least a first set of data and a second set of data; and a processing system containing one or more processors, the processing system being configured to generate a first view, a second view, and associated generating-vectors, wherein the first and second views are generated by combining the first and second sets of data, such that the first view contains information associated with elements of the first set of data, the second view contains information associated with elements of the second set of data other than elements of the second set of data that are in common with corresponding elements of the first set of data, and the associated generating-vectors indicate operations to be performed on the elements of the first and second views to recover the first and second sets of data.

In an optional embodiment, the system includes a storage module configured to store the first view, the second view, and the associated generating-vectors in association with each other.

According to the teachings of the present embodiment there is provided a system for decoding data including: a data-receiving module configured to receive at least: a first view and a second view, the first and second views containing information associated with elements of a first set of data and a second set of data such that the first view contains information associated with elements of the first set of data, and the second view contains information associated with elements of the second set of data other than elements of the second set of data that are in common with corresponding elements of the first set of data; and generating-vectors associated with the first and second views, the generating-vectors indicating operations to be performed on elements of the first and second views to generate the first and second set of data; and a processing system containing one or more processors, the processing system being configured to generate, using the first view, the second view, and the generating-vectors, at least the first set of data.

According to the teachings of the present embodiment there is provided a method for encoding data including the steps of: generating a first fused data set including a first view, a second view, and a first set of associated generating-vectors wherein the first and second views are generated by combining a first set of data and a second set of data, such that the first view contains information associated with elements of the first set of data, the second view contains information associated with elements of the second set of data other than elements of the second set of data that are in common with corresponding elements of the first set of data, and the first set of associated generating-vectors indicate operations to be performed on the elements of the first and second views to recover the first and second sets of data; generating a decoded second view using the first fused data set, the decoded second view substantially the same as the second set of data; and generating a third view, and a second set of associated generating-vectors wherein the third view is generated by combining the decoded second view and a third set of data, such that the third view contains information associated with elements of the third set of data other than elements of the third set of data that are in common with corresponding elements of the decoded second view, and the second set of associated generating-vectors indicate operations to be performed on the elements of the decoded second view and third views to recover the second and third sets of data.

In an optional embodiment, the steps of generating a decoded second view and generating a third view, are repeated to generate a higher-level fused data set, the higher-level fused data set including a higher-level decoded view from a lower-level fused data set.

In an optional embodiment, the method further includes the step of: storing the first fused data set, the third view, and the second set of associated generating-vectors in association with each other.

According to the teachings of the present embodiment there is provided a method for decoding data including the steps of: receiving a first fused data set including a first view, a second view, and a first set of associated generating-vectors, the first and second views containing information associated with elements of a first set of data and a second set of data such that the first view contains information associated with elements of the first set of data, and the second view contains information associated with elements of the second set of data other than elements of the second set of data that are in common with corresponding elements of the first set of data, and the a first set of associated generating-vectors indicating operations to be performed on elements of the first and second views to render the first and second set of data; generating at least a decoded second view using the first fused data set, the decoded second view substantially the same as the second set of data; and generating a decoded third view using a second fused data set, the second fused data set including the decoded second view, a third view and a second set of associated generating-vectors, wherein the third view contains information associated with elements of a third set of data other than elements of the third set of data that are in common with corresponding elements of the second set of data, the second set of associated generating-vectors indicating operations to be performed on elements of the decoded second view and the third view to render the decoded third view, the decoded third view substantially the same as the third set of data.

In an optional embodiment, the step of generating a decoded third view is repeated to generate a higher-level decoded view using a higher-level fused data set, the higher-level fused data set including a decoded view from a lower-level fused data set.

In an optional embodiment, the method includes the step of: generating a decoded first view using the first fused data set, the decoded first view substantially the same as the first set of data.

According to the teachings of the present embodiment there is provided a system for encoding data including: a data-receiving module configured to receive at least a first set of data, a second set of data, and a third set of data; and a processing system containing one or more processors, the processing system being configured to: generate a first fused data set including a first view, a second view, and a first set of associated generating-vectors wherein the first and second views are generated by combining a first set of data and a second set of data, such that the first view contains information associated with elements of the first set of data, the second view contains information associated with elements of the second set of data other than elements of the second set of data that are in common with corresponding elements of the first set of data, and the first set of associated generating-vectors indicate operations to be performed on the elements of the first and second views to recover the first and second sets of data; generate a decoded second view using the first fused data set, the decoded second view substantially the same as the second set of data; and generate a third view, and a second set of associated generating-vectors wherein the third view is generated by combining the decoded second view and a third set of data, such that the third view contains information associated with elements of the third set of data other than elements of the third set of data that are in common with corresponding elements of the decoded second view, and the second set of associated generating-vectors indicate operations to be performed on the elements of the decoded second view and third views to recover the second and third sets of data.

In an optional embodiment, the system includes a storage module configured to store the first fused data set, the third view, and the second set of associated generating-vectors in association with each other.

According to the teachings of the present embodiment there is provided a system for decoding data including: a data-receiving module configured to receive at least a first fused data set including a first view, a second view, and a first set of associated generating-vectors, the first and second views containing information associated with elements of a first set of data and a second set of data such that the first view contains information associated with elements of the first set of data, and the second view contains information associated with elements of the second set of data other than elements of the second set of data that are in common with corresponding elements of the first set of data, and the a first set of associated generating-vectors indicating operations to be performed on elements of the first and second views to render the first and second set of data; and a processing system containing one or more processors, the processing system being configured to: generate at least a decoded second view using the first fused data set, the decoded second view substantially the same as the second set of data; and generate a decoded third view using a second fused data set, the second fused data set including the decoded second view, a third view and a second set of associated generating-vectors, wherein the third view contains information associated with elements of a third set of data other than elements of the third set of data that are in common with corresponding elements of the second set of data, the second set of associated generating-vectors indicating operations to be performed on elements of the decoded second view and the third view to render the decoded third view, the decoded third view substantially the same as the third set of data.

According to the teachings of the present embodiment there is provided a computer-readable storage medium having embedded thereon computer-readable code for encoding data the computer-readable code including program code for: receiving a first set of data; receiving a second set of data; generating a first view, a second view, and associated generating-vectors; wherein the first and second views are generated by combining the first and second sets of data, such that the first view contains information associated with elements of the first set of data, the second view contains information associated with elements of the second set of data other than elements of the second set of data that are in common with corresponding elements of the first set of data, and the associated generating-vectors indicate operations to be performed on the elements of the first and second views to recover the first and second sets of data.

According to the teachings of the present embodiment there is provided a computer-readable storage medium having embedded thereon computer-readable code for decoding data the computer-readable code including program code for: receiving a first view and a second view, the first and second views containing information associated with elements of a first set of data and a second set of data such that the first view contains information associated with elements of the first set of data, and the second view contains information associated with elements of the second set of data other than elements of the second set of data that are in common with corresponding elements of the first set of data; receiving generating-vectors associated with the first and second views, the generating-vectors indicating operations to be performed on elements of the first and second views to generate the first and second set of data; and generating, using the first view, the second view, and the generating-vectors, at least the first set of data.

According to the teachings of the present embodiment there is provided a computer-readable storage medium having embedded thereon computer-readable code for encoding data the computer-readable code including program code for: generating a first fused data set including a first view, a second view, and a first set of associated generating-vectors wherein the first and second views are generated by combining a first set of data and a second set of data, such that the first view contains information associated with elements of the first set of data, the second view contains information associated with elements of the second set of data other than elements of the second set of data that are in common with corresponding elements of the first set of data, and the first set of associated generating-vectors indicate operations to be performed on the elements of the first and second views to recover the first and second sets of data; generating a decoded second view using the first fused data set, the decoded second view substantially the same as the second set of data; and generating a third view, and a second set of associated generating-vectors wherein the third view is generated by combining the decoded second view and a third set of data, such that the third view contains information associated with elements of the third set of data other than elements of the third set of data that are in common with corresponding elements of the decoded second view, and the second set of associated generating-vectors indicate operations to be performed on the elements of the decoded second view and third views to recover the second and third sets of data.

According to the teachings of the present embodiment there is provided a computer-readable storage medium having embedded thereon computer-readable code for decoding data the computer-readable code including program code for: receiving a first fused data set including a first view, a second view, and a first set of associated generating-vectors, the first and second views containing information associated with elements of a first set of data and a second set of data such that the first view contains information associated with elements of the first set of data, and the second view contains information associated with elements of the second set of data other than elements of the second set of data that are in common with corresponding elements of the first set of data, and the a first set of associated generating-vectors indicating operations to be performed on elements of the first and second views to render the first and second set of data; generating at least a decoded second view using the first fused data set, the decoded second view substantially the same as the second set of data; and generating a decoded third view using a second fused data set, the second fused data set including the decoded second view, a third view and a second set of associated generating-vectors, wherein the third view contains information associated with elements of a third set of data other than elements of the third set of data that are in common with corresponding elements of the second set of data, the second set of associated generating-vectors indicating operations to be performed on elements of the decoded second view and the third view (RO23) to render the decoded third view, the decoded third view substantially the same as the third set of data.

### BRIEF DESCRIPTION OF FIGURES

The embodiment is herein described, by way of example only, with reference to the accompanying drawings, wherein:

FIG. 1 is a diagram of a fused 2D view.

FIG. 2 is a diagram of exemplary GOC operations for the LRO format.

FIG. 3A is a diagram of an LRO fused view format.

FIG. 3B is a diagram of an RLO format.

FIG. 4 is a flow diagram of processing for an MLE CODEC encoder based on the LRO format.

FIG. 5 is a flow diagram of processing for an MLE CODEC decoder based on the LRO format.

FIG. 6 is a flow diagram of processing for an MLE CODEC encoder based on the RLO format.

FIG. 7 is a flow diagram of processing for an MLE CODEC decoder based on the RLO format.

FIG. 8 is a flow diagram of processing for an MLE CODEC encoder based on a combination of the LRO and RLO formats.

FIG. 9 is a flow diagram of processing for an MLE CODEC decoder based on a combination of the LRO and RLO formats.

FIG. 10 is a diagram of a system for LRO and MULTIVIEW encoding and decoding.

### DETAILED DESCRIPTION

The principles and operation of the method and system according to a present embodiment may be better understood with reference to the drawings and the accompanying description. A present invention is a system and method for encoding 3D content with reduced power consumption, in particular reduced decoder power consumption, as compared to conventional techniques.

An innovative implementation of 3D+F includes an innovative format that includes one of the original views, in contrast to the previously taught 3D+F format that is generated from the original views but does not contain either of the original two views. This innovative format is referred to in the context of this document as the “LRO format”. In addition to providing images for three-dimensional (3D) viewing, the LRO format can provide compatibility with two-dimensional (2D) applications. The LRO format has been shown to provide images that are at least the quality of images provided by conventional encoding techniques using equivalent bandwidth, with the ability in some cases to provide higher quality images than conventional encoding techniques. A significant feature of the LRO format is that encoding and decoding images requires less power than conventional encoding and decoding formats. The LRO format facilitates encoding of multiple images using an innovative multiview low energy (MLE) CODEC.

The innovative MLE CODEC reduces the power consumption requirements of encoding and decoding 3D content, as compared to conventional techniques. A significant feature of the MLE CODEC is that a decoded view from a lower processing level is used for one of the components of the LRO format for at least one higher processing level. Thus, some components of the LRO level for a higher view can be derived from processing of lower views, and not all the components of the higher view need to be transmitted as part of the data for the MLE CODEC.

WIPO application PCT/IB2010/051311 (attorney file 4221/4) teaches a method and system for minimizing power consumption for encoding data and three-dimensional rendering. This method, called 3D+F, makes use of a special format and consists of two main components, a fused view portion and a generating-vectors portion. For clarity in this document, the 3D+F format taught in PCT/IB2010/051311 is referred to as the “original 3D+F format” versus the innovative format of the current invention which is generally referred to as the “LRO format”.

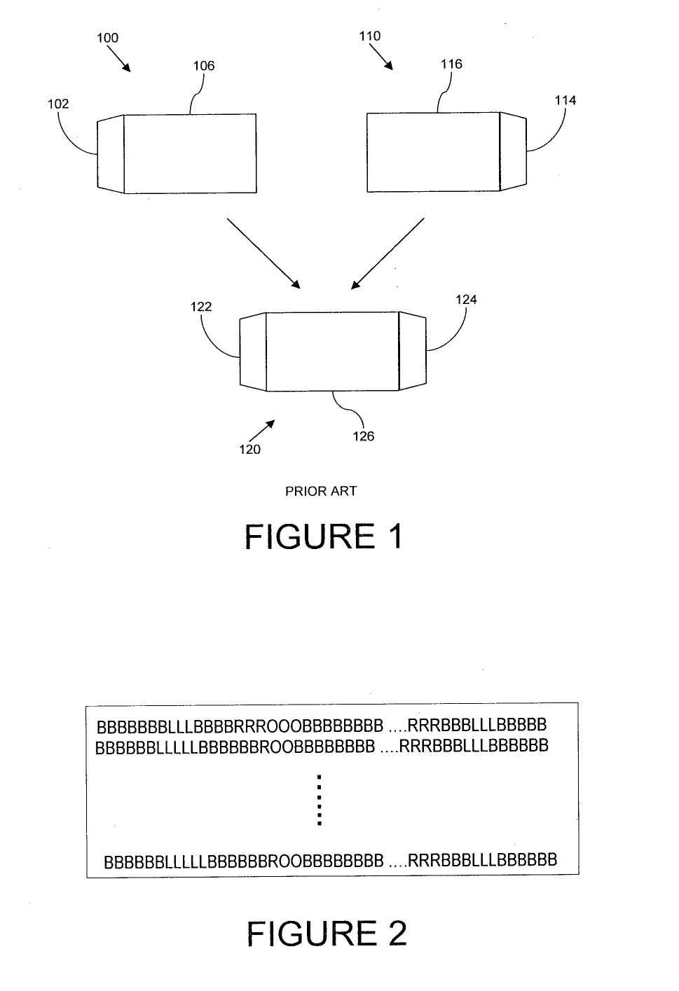

Referring to FIG. 1, a diagram of a fused 2D view, a fused view 120 is obtained by correlating a left view 100 and a right view 110 of a scene to derive a fused view, also known as a single cyclopean view, 120, similar to the way the human brain derives one image from two images. While each of a left and right view (image) contains information only about the respective view, the fused view includes all the information necessary to render efficiently left and right views. In the context of this document, the terms “view” and “image” are generally used interchangeably. In the context of this document, the term “scene” generally refers to what is being viewed. A scene can include one or more objects or a place that is being viewed. A scene is viewed from a location, referred to as a viewing angle. In the case of stereovision, two views, each from different viewing angles are used. Humans perceive stereovision using one view captured by each eye. Technologically, two image capture devices, for example video cameras, at different locations provide images from two different viewing angles for stereovision.

In a non-limiting example, left view 100 of a scene, in this case a single object, includes the front of the object from the left viewing angle 106 and the left side of the object 102. Right view 110 includes the front of the object from the right viewing angle 116 and the right side of the object 114. The fused view 120 includes information for the left side of the object 122, information for the right side of the object 124, and information for the front of the object 126. Note that while the information for the fused view left side of the object 122 may include only left view information 102, and the information for the fused view right side of the object 124 may include only right view information 114, the information for the front of the object 126 includes information from both left 106 and right 116 front views.

In particular, features of a fused view include:
A fused view can be generated without occluded elements. In the context of this document, the term element generally refers to a significant minimum feature of an image. Commonly, an element will be a pixel, but depending on the application and/or image content, an element can be a polygon or area. The term pixel is often used in this document for clarity and ease of explanation. Every pixel in a left or right view can be rendered by copying a corresponding pixel (sometimes copying more than once) from a fused view to the correct location in a left or right view.
The processing algorithms necessary to generate the fused view work similarly to how the human brain processes images, therefore eliminating issues such as light and shadowing of pixels.

Preferably, the fused view of the 3D+F format does not contain any occluded pixels. In other words, every pixel in the fused view is in the left, right, or both the left and right original images. There are no (occluded) pixels in the fused view that are not in either the left or the right original images. A significant feature of the 3D+F format is the ability of a fused view to be constructed without the fused view containing occluded pixels. This feature should not be confused with occluded pixels in the original images, which are pixels that are visible in a first original image, but not a second original image. In this case, the pixels that are visible only in the first original image are occluded for the second original image. The pixels that are occluded for the second original image are included in the fused view, and when the fused view is decoded, these occluded pixels are used to re-generate the first original image.

One ordinarily skilled in the art will understand that references to pixels that are visible in one image and in another image refer to corresponding pixels as understood in the stereo literature. Due to the realities of 3D imaging technology such as stereo 3D (S3D), including, but not limited to sampling, and noise, corresponding pixels are normally not exactly the same, but depending on the application, sufficiently similar to be used as the same pixel for processing purposes.

The type of fused view generated in the original 3D+F format depends on the application. One type of fused view includes more pixels than either of the original left or right views. This is the case described in reference to FIG. 1. In this case, all the occluded pixels in the left or right views are integrated into the fused view. In this case, if the fused view were to be viewed by a user, the view is a distorted 2D view of the content. Another type of fused view has approximately the same amount of information as either the original left or right views. This fused view can be generated by mixing (interpolating or filtering) a portion of the occluded pixels in the left or right views with the visible pixels in both views. In this case, if the fused view were to be viewed by a user, the view will show a normal 2D view of the content. This normal (viewable) 2D fused view in the original 3D+F format has been nonlinearly warped so that the fused view appears as a normal 2D view. However, this fused view is not similar to either the original left or original right views in the sense that besides pixels that are in both original views, the fused view includes pixels that are only in the right original view and pixels that are only in the left original view. Note that 3D+F can use either of the above-described types of fused views, or another type of fused view, depending on the application. The encoding algorithm should preferably be designed to optimize the quality of the rendered views. The choice of which portion of the occluded pixels to be mixed with the visible pixels in the two views and the choice of mixing operation can be done in a process of analysis by synthesis. For example, using a process in which the pixels and operations are optimally selected as a function of the rendered image quality that is continuously monitored.

Algorithms for performing fusion are known in the art, and are typically done using algorithms of stereo matching. Based on this description one skilled in the art will be able to choose the appropriate fusion algorithm for a specific application and modify the fusion algorithm as necessary to generate the associated generating-vectors for 3D+F.

A second component of the 3D+F format is a generating-vectors portion, also referred to as generic-vectors. The generating-vectors portion includes a multitude of generating-vectors, more simply referred to as the generating-vectors. Two types of generating-vectors are left generating-vectors and right generating-vectors used to generate a left view and right view, respectively.

A first element of a generating-vector is a run-length number that is referred to as a generating number (GN). The generating number is used to indicate how many times an operation (defined below) on a pixel in a fused view should be repeated when generating a left or right view. An operation is specified by a generating operation code, as described below.

A second element of a generating-vector is a generating operation code (GOC), also simply called “generating operators” or “operations”. A generating operation code indicates what type of operation (for example, a function, or an algorithm) should be performed on the associated pixel(s). Operations can vary depending on the application. In a preferred implementation, at least the following operations are available:
Copy: copy a pixel from a fused view to the view being generated (left or right). If GN is equal to n, the pixel is copied n times.
Occlude: occlude a pixel. For example, do not generate a pixel in the view being generated. If GN is equal to n, do not generate n pixels, meaning that n pixels from the fused view are occluded in the view being generated.
Go to next line: current line is completed; start to generate a new line.
Go to next frame: current frame is completed; start to generate a new frame.

A non-limiting example of additional and optional operations includes Copy-and-Filter: the pixels are copied and then smoothed with the surrounding pixels. This operation could be used in order to improve the imaging quality, although the quality achieved without filtering is generally acceptable.

### DETAILED DESCRIPTION

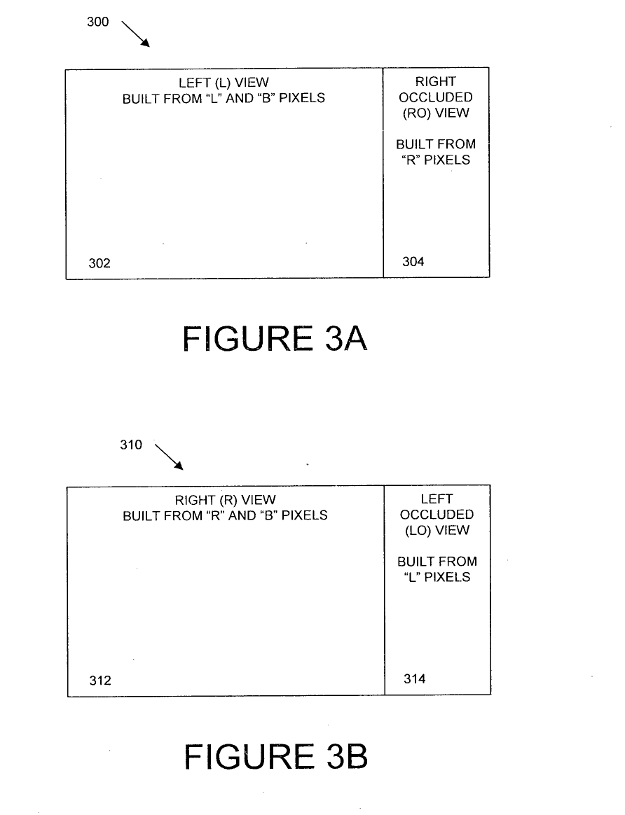

### First Embodiment—FIGS. 2 to 3

### LRO Fused Data Format

An innovative implementation of 3D+F includes an innovative format that includes one of the original views, in contrast to the previously taught 3D+F format that is generated from the original views but does not contain either of the original two views. In the context of this document, this innovative format is referred to as LRO (left view, right occlusions) or as RLO (right view, left occlusions). For simplicity and clarity in the description, the LRO/RLO format is generally referred to as just the LRO format. One skilled in the art will understand that references to either the LRO or RLO apply to both formats, except where a specific construction is being described. Although the previously taught 3D+F format does contain the original views, in the sense that the original views can be re-generated from the 3D+F format, this should not be confused with the innovative LRO format described below that contains an original view as the original view per se. In other words, the original view does not need to be generated, but can be extracted from the LRO/RLO format. As described above, a viewable 2D fused view in the original 3D+F format has been nonlinearly warped so that the fused view appears as a normal 2D view. However, this viewable fused view is not similar to either the original left or original right views. In contrast, in the LRO format (as opposed to the RLO format), the left view can be the original left view, and the right view includes the elements occluded from the left view, in other words, the elements of the original right view that are not visible in the original left view. Elements common to both the original left and right views are included in the left view of the LRO fused view. Note that in the above description of the right view the elements included in the right view are not exclusive. In other words, in addition to the occlusions, the right view can also include padding information. This padding information can also be pixels that are in common with the left view.

Referring to FIG. 2, a diagram of exemplary GOC operations for the LRO format, the GOC operations of the generating-vectors can be simply graphically represented as indicated by the following labels:
B: copy pixel from fused view to both the left and right views.
L: copy pixel from fused view to left view.
R: copy pixel from fused view to right view.
O: occlude pixel (skip): this generating-vector may be used to insert padding pixels (into the right view of the LRO fused view) that are not used in the view being generated, but are included in the fused view to increase the quality of the rendered views. Padding can also be used to enable more efficient processing (such as compression) of the fused view. Padding data is added to the fused view making the fused view larger, but enabling a compression algorithm to compress the larger fused view into a smaller amount of data to be transmitted, as compared to compressing a relatively smaller fused view into a relatively larger amount of data to be transmitted.

As long as the generating-vectors are able to point to the correct pixels on which the generating-vectors need to act in the fused view to generate the correct pixels on the right and left views, the fused view can be arbitrarily generated. In other words, the pixel positions on the LRO fused view can be changed as long as these pixels can be retrieved for generating the left and right views.

A non-limiting example of associating the generating-vectors (GVs) with the corresponding pixels on which the GVs need to act can be seen in the embodiment of FIG. 2. The B, L, and R GVs form a frame. In this frame, the GVs are located at a position such that retrieving sequentially pixels from the fused view and reading the corresponding GVs, the pixels retrieved are either skipped (0 GV), copied to both left and right images (B), copied only in the left image (L), or copied only in the right images (R). The value of the GV points to the operation on the corresponding pixel.

Continuing the current example using FIG. 2, two (2) bits are necessary to represent the four values B, R, L, and O. In a case where padding is not used, only the two values B and R are required, and 2 values can be represented by only one bit. Once a map of generating-vectors is created per frame, the map can be compressed using run length coding or other types of efficient entropy coding.

In one non-limiting example, different fused views can be generated by varying the padding in the fused views. As the padding is not used to generate the decoded original left and right views, different fused views can generate similar decoded original left and right views. Generating alternative fused views may have system benefits, including greater compressibility, or improved quality after transmission (such as by h.264 compression).

A key feature of a method of generating an LRO format is arranging the pixel positions of the fused view to optimize subsequent processing, typically image quality and compression encoding, while maintaining association between pixels of the LRO fused view and corresponding generating-vectors. In other words, the pixel positions of the LRO fused view can be changed for maximum benefit of the specific application for which the LRO fused view is being used.

In a non-limiting example application of wireless transmission, the LRO fused view needs to be compressed by a compression algorithm such as H.264/MPEG4. Maximum benefit for this application includes using an LRO fused view that yields a very good compression rate by the compression algorithm being used, for example by H.264/MPEG4.

Referring to FIG. 3A, a diagram of an LRO fused view format, an LRO fused view 300 includes a left view 302 and right occlusions view 304. The left view 302 is built from the L (left) and B (both) pixels corresponding to the L generating-vectors and the B generating-vectors, respectively. The L generating-vectors and B generating-vectors use the L pixels and B pixels, respectively, to generate (re-generate) the original left view. The right occlusions view 304 is built from the R (right) pixels corresponding to the R generating-vectors and optionally of padding pixels built from the O pixels (refer back to FIG. 2) corresponding the O generating-vectors. Note that the padding pixels can be pixels common to the right and left original images. The R generating-vectors and B generating-vectors use the R pixels and B pixels, respectively, to generate (re-generate) the original right view.

In general, the LRO format is a method of storing data, the first step of the method being similar to the above-described method for generating an LRO fused data format for a first and second data set. In a case where the first data set is a first two-dimensional (2D) image, and the second data set is a second 2D image, the general method for storing data can be used for encoding data, in this case 2D images.

A method for encoding LRO format data includes the steps of receiving a first two-dimensional (2D) image of a scene from a first viewing angle and a second 2D image of the scene from a second viewing angle. A first view, a second view, and associated generating-vectors are generated using the first and second 2D images. The first view, a second view, and associated generating-vectors can be stored in association with each other, temporarily, permanently, and/or transmitted. The first and second views are generated by combining the first and second 2D images. The first view contains information associated with elements of the first 2D image. The second view contains information associated with elements of the second 2D image other than elements of the second 2D image that are in common with corresponding elements of the first 2D image. As described above, the second view may also include other elements, such as padding. The associated generating-vectors indicate operations to be performed on elements of the first and second views to recover the first and second 2D images. Preferably, the first view is substantially identical to the first 2D image.

The first view includes elements that are common to the first and second sets of data. In one implementation, the second view only contains information associated with elements of the second set of data other than elements of the second set of data that are in common with corresponding elements of the first set of data. In another implementation, the second view contains additional information. The additional information is information other than information only associated with elements of the second set of data other than elements of the second set of data that are in common with corresponding elements of the first set of data. In other words, the additional information is padding, which can be implemented as elements from the first set of data, or as other elements that are identified by the generating-vectors to not be used to generate views.

In general, a method for decoding LRO format data includes the step of providing a first view and a second view. Similar to the description above in reference to encoding LRO format data, the first and second views contain information associated with elements of a first 2D image and a second 2D image. The first view contains information associated with elements of the first 2D image. The second view contains information associated with elements of the second 2D image other than elements of the second 2D image that are in common with corresponding elements of the first 2D image. As described above, the second view may also include other elements, such as padding. Generating-vectors associated with the first and second views are provided. The associated generating-vectors indicate operations to be performed on elements of the first and second views to render the first and second 2D images. Using the first view, the second view, and the associated generating-vectors, at least the first 2D image is rendered. Preferably, the first view is the first 2D image. So rendering the first 2D image can be done by simply extracting the first view, which is the first 2D image, from the encoded data. Using the first view, the second view, and the generating-vectors, the second 2D image can be rendered.

Note that instead of generating an LRO fused view as a single file, two or more files (for example, two separate views) can be generated, one file for the left view (“L”, the part built from the left (L) and both (B) pixels), another file for the right occlusions view (“RO”, the part built from the right (R) pixels and optionally from the “O” pixels, for example for padding). Generating-vectors (GVs) are also generated, and can be included in the left view, right occlusions view, or preferably in a separate file. In this case, the term LRO fused view refers to both (or in general, all) of the generated files. The two views can be separately encoded using different settings in the H.264/MPEG4 compression scheme. Whether one view or multiple views are used for the data of the fused view, the resulting LRO fused view achieves a compression with H.264/MPEG4 that is at least as good as the compression of the previously taught 3D+F format of FIG. 1. The good compression ratio results in part from the right side view being compact. Also, since the right side view consists of right occlusions that have a reasonable degree of coherence from frame to frame, the right view tends to have good. H.264/MPEG4 compression. In contrast, in order for the original 3D+F format previously taught in reference to FIG. 1 to achieve improved H.264/MPEG4 compression, the original 3D+F format requires padding pixels in order to preserve inter-line pixel coherence, and therefore is not as compact as the innovative LRO format described in reference to FIG. 3A.

As described above, the LRO format facilitates arranging the pixel positions of the fused view to optimize subsequent processing. In a typical case, the pixels of the left view 302 are chosen such that the left view is the original left image, and the pixels of the right occlusions view 304 are the pixels that are occluded from the left view (the elements of the original right image that are not visible in the left image and optional padding). As the right occlusions view is missing elements from the original right image, the quality of an image decoded from the right occlusions view may be able to be increased by padding the right occlusions view. In this case, the decoded image can be monitored and the quality of the decoded image used for feedback to the fused view generator, modifying how padding is applied in the generation of the fused views. Separately or in combination with applying padding for increased image quality, padding can be applied to increase the compression ratio of the fused view, in particular for the right occlusions view. The right occlusions view is padded sufficiently so that the compression algorithm being used (for example H.264 for wireless transmission of the data) processes the data of the right occlusions view similar to processing of an original image. Thus, the compression ratio of the padded right view can be higher than the compression ratio of an un-padded right occlusions view.

Regarding the use of padding, note that while both the original 3D+F format and the LRO format can use padding in the generated fused view, padding is not required in either format. In addition, how padding is used and the effect on the size of the fused view are different between the two formats. As described above, padding can optionally be used in the original 3D+F format, but this padding affects the quality of the rendered view, and increases the size of the fused view by a relatively larger amount. In other words, when padding is used in the original 3D+F format, a larger amount of data is added to the fused view than the relatively smaller amount of data added when padding is added to the fused view of the LRO format. When padding is optionally used in the LRO format, padding affects the compression ratio of the data of the fused view, with a relatively smaller amount of data added only to the right occlusions view (“RO”, the part built from the right (R) pixels and optional padding). As shown in FIG. 3A and FIG. 1 by the relative size of the left view 302, which is comparable to the front of the object 126, and right occlusions view 304, the right occlusions view 304 is relatively smaller than the left view 302 to begin with, so the added padding to the LRO format right occlusions view 304 is less than the occlusions added to the front of the object 126.

Referring to FIG. 3B, a diagram of an RLO format, a right view-left occlusions (RLO) format can be derived from the fused view. The RLO format is similar to the LRO format, with the right view corresponding to the B and R pixels of the fused view while the left occlusions part is built from the L pixels and optionally from the 0 pixels, similar to the description of FIG. 2. An RLO fused view 310 includes a right view 312 and left occlusions view 314. The right view 312 is built from the R (right) and B (both) pixels corresponding to the R generating-vectors and the B generating-vectors, respectively. The R generating-vectors and B generating-vectors use the R pixels and B pixels, respectively, to generate (re-generate) the original right view. The left occlusions view 314 is built from the L (left) pixels corresponding to the L generating-vectors and optionally from the 0 pixels, similar to the description of FIG. 2. The L generating-vectors and B generating-vectors use the L pixels and B pixels, respectively, to generate (re-generate) the original left view.

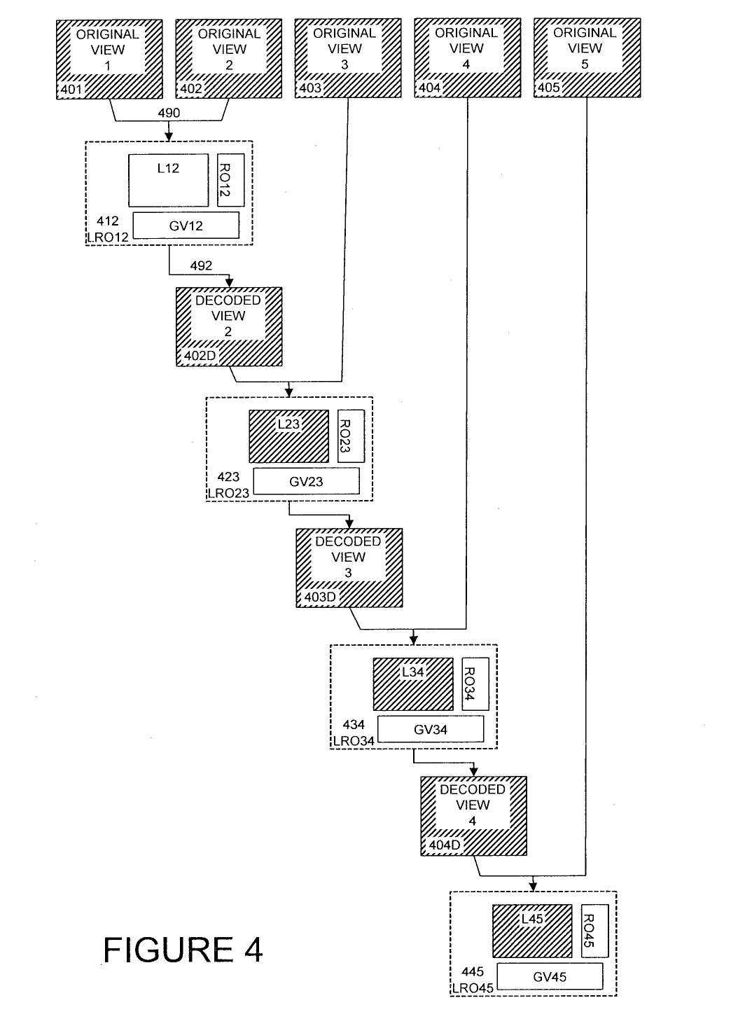

### Second Embodiment—FIGS. 4 to 10

While the above-described embodiment for an LRO format is useful, an additional method can be used in conjunction or independently, for handling multiple three-dimensional (3D) views, known as multiview 3D. As described above, the power consumption requirements of multiview 3D are a challenge for decoding chips and for energy saving regulations. The innovative method and system of a multiview 3D CODEC (encoder/decoder) reduces the power consumption requirements of encoding and decoding 3D content, as compared to conventional techniques. This innovative multiview 3D CODEC is referred to in the context of this document as a multiview low energy CODEC, or simply MLE CODEC. A feature of the MLE CODEC is a much lower power requirement as compared to H.264-MVC. In particular, generating (also referred to in the industry as synthesizing) decoded views during encoding is a significant feature of the current invention, and has been shown to be less power consuming than implementations which synthesize views at the decoder/receiver stage.

For clarity, multiview 3D is herein described using the LRO (RLO) format. It is foreseen that based on the above description of the LRO format, and the below-description of multiview 3D, modifications to the LRO format for specific applications are possible, and any format that supports the innovative characteristics of the LRO format to facilitate multiview 3D can be used for multiview 3D. A non-limiting example of modifications to the LRO format include changing the structure of the frames (refer again to FIG. 3), while keeping the meaningful information substantially intact.

MLE Encoder Based on the LRO Format

Referring to FIG. 4, a flow diagram of processing for an MLE CODEC encoder based on the LRO format, a non-limiting example of 5 views is encoded. In the context of this document, the MLE CODEC encoder is also referred to as simply the MLE encoder. Based on this description, one skilled in the art will be able to extend this encoding method to an arbitrary number of views, including more views and fewer views. Below, further embodiments are described based on the RLO format, and both LRO and RLO formats. 5 original views, original view 1 (401), original view 2 (402), original view 3 (403), original view 4 (404), and original view 5 (405), are encoded to produce a smaller amount of data, as compared to the amount of data in the original views. Original view 1 (401) and original view 2 (402) are used to generate LRO format for views 1 and 2 LRO12 412, similar to the above described method for S3D with original view 1 (401) used as the left view and original view 2 (402) used as the right view. LRO12 contains a left view L12 [the part built from the left (L) and both (B) pixels], a right occlusions view RO12 [the part built from the right (R) pixels, and optionally from the occlusion (O) pixels, for example such as padding], and generating-vectors GV12 (generating-vectors to regenerate the original left and right views). Note that in the preferred embodiment described above in reference to the LRO format, as all of the pixels for the original view 1 (401) are in the left view (L12) and only pixels for original view 2 (402) are in the right occlusions view (RO12), so an alternative notation could be used in which L12 is L1 and RO12 is R2. However, for consistency and compatibility, the L12 and RO12 notation is maintained in this document.

L12, RO12, and GV12 will all be required by the MLE CODEC decoder, so are part of the produced data, and fully contribute to a bit rate and bandwidth required for transmission. The original views (in this case original view 1 (401) and original view 2 (402) do not need to be transmitted. For clarity in the figures, items that do not need to be transmitted are striped, while items to be transmitted are not filled-in.

After generating LRO12, LRO12 is decoded to generate decoded view 2 (402D). While theoretically decoded view 2 (402D) can be the same as original view 2 (402), depending on the application and encoding parameters chosen, decoded view 2 (402D) and original view 2 (402) may be more or less similar. In other words, the quality of decoded view 2 (402D) as compared to original view 2 (402) may be substantially the same, or a lower quality. In general, the two views, decoded view 2 (402D) and original view 2 (402) are substantially the same, meaning that for a given application the differences between the two views are below a given threshold.

Decoded view 2 (402D) and original view 3 (403) are used to generate LRO format LRO23 423, similar to the above described method for LRO12. LRO23 contains a left view L23, a right occlusions view RO23, and generating-vectors GV23. A significant feature of the method of this encoding is that decoded view 2 (402D) is used for left view L23. L23, RO23, and GV23 will all be required by the MLE CODEC decoder. However, since decoded view 2 (402D) is used for left view L23, left view L23 does not have to be part of the produced data for LRO23. Fused view LRO12 is already transmitted, and can be used by the MLE CODEC decoder to produce decoded view 2 (402D) which can be used as the L23 part of LRO23. Hence, from LRO23, only the RO23 and GV23 parts need to be transmitted. LRO23 does not fully contribute to the bit rate and bandwidth required for transmission, as L23 does not need to be transmitted. This contributes significantly to the bandwidth savings.

Note that in addition to only needing to transmit one of the two views (only RO23), since the non-transmitted view (L23) contains the left (L) and both (B) pixels, the view that is transmitted (RO23) contains only the right occlusion and optional padding (RO) pixels, which is generally a smaller amount of data than the view not-transmitted (L23).

After generating LRO23, the method repeats, decoding LRO23 to generate decoded view 3 (403D). Decoded view 3 (403D) is substantially the same as original view 3 (403). Decoded view 3 (403D) and original view 4 (404) are used to generate LRO format LRO34 434, similar to the above described method for LRO12. LRO34 contains a left view L34, a right occlusions view RO34, and generating-vectors GV34. Similar to the description in reference to left view L23, decoded view 3 (403D) is used for left view L34. L34, RO34, and GV34 will all be required by the MLE CODEC decoder. However, since decoded view 3 (403D) is used for left view L34, left view L34 does not have to be part of the produced data for LRO34. Data for fused view LRO23 is already available from transmitted data, and can be used by the MLE CODEC decoder to produce decoded view 3 (403D) which can be used as the L34 part of LRO34. Hence, from LRO34, only the RO34 and GV34 parts need to be transmitted. LRO34 does not fully contribute to the bit rate and bandwidth required for transmission, as L34 does not need to be transmitted.

As noted above in reference to LRO23 in addition to only needing to transmit one of the two views (only RO34), since the non-transmitted view (L34) contains the left (L) and both (B) pixels, the view that is transmitted (RO34) contains only the right occlusion and optional padding (RO) pixels, which is generally a smaller amount of data than the view not-transmitted (L34).

After generating LRO34, the method repeats as already described, decoding LRO34 to generate decoded view 4 (404D). Decoded view 4 (404D) is substantially the same as original view 4 (404). Decoded view 4 (404D) and original view 5 (405) are used to generate LRO format LRO45 445, similar to the above described method for LRO12. LRO45 contains a left view L45, a right occlusions view RO45, and generating-vectors GV45. Similar to the description in reference to left view L23, decoded view 4 (404D) is used for left view L45. L45, RO45, and GV45 will all be required by the MLE CODEC decoder. However, since decoded view 4 (404D) is used for left view L45, left view L45 does not have to be part of the produced data for LRO45. Fused view LRO34 is already transmitted, and can be used by the MLE CODEC decoder to produce decoded view 4 (404D) which can be used as the L45 part of LRO45. Hence, from LRO45, only the RO45 and GV45 parts need to be transmitted. LRO45 does not fully contribute to the bit rate and bandwidth required for transmission, as L45 does not need to be transmitted.

The original data for the current example includes 5 original views. The data produced by the encoder includes only one original view [original view 1 (401)], left view L12, with four right views RO12, RO23, RO34, and RO45 and correspondingly only four sets of generating-vectors GV12, GV23, GV34, and GV45.

It will be obvious to one skilled in the art that the views can be combined in an arbitrary order, with different combinations requiring potentially different amounts of processing power, producing different resulting compression ratios, and different quality decoded images.

In general, the multiview (fused data) format is a method of storing data, the first step of the method being similar to the above-described method for generating an LRO fused data format for a first and second data set. In a case where the first data set is a first two-dimensional (2D) image, and the second data set is a second 2D image, the general method for storing data can be used for encoding data, in this case 2D images. Generating data in the multiview format can be done by a MLE CODEC encoder.

A first fused data set includes a first view, a second view, and a first set of associated generating-vectors. The first and second views are generated by combining a first set of data and a second set of data. The first view contains information associated with elements of the first set of data. In the preferred implementation of the LRO fused data format, the first view contains only information associated with elements of the first set of data. Most preferably, the first view is the first set of data. Note that this first view is not exclusive, in that the first view does not exclude information that is also associated with elements of the second set of data. The second view contains information associated with elements of the second set of data, preferably other than elements of the second set of data that are in common with corresponding elements of the first set of data, except for optional padding. In other words, the second view contains information associated with elements of the second set of data that are not in common with corresponding elements of the first set of data, except for optional padding. The first set of associated generating-vectors indicates operations to be performed on the elements of the first and second views to recover the first and second sets of data. In the above description of the LRO format, there is one set of generating-vectors for one set of views. When generating multiple fused views, each set of views has an associated set of generating-vectors. In the context of this document, the term “associated generating-vectors” generally refers to the generating-vectors associated with the two views of the LRO fused data format for which the vectors are used to generate the original (or decoded) two images.

The next step in storing data in the multiview format is generating a decoded second view using the first fused data set. Decoding can be done using the technique described above for decoding the LRO fused data format. The decoded second view is substantially the same as the second set of data.

For clarity, the next step can be thought of as generating a second fused data set. The second fused data set includes the decoded second view, a third view, and a second set of associated generating-vectors. Practically, generating a formal second fused data set is not necessary. The decoded second view has already been generated, and the decoded second view does not need to be stored nor transmitted in the multiview format. A third view and a second set of associated generating-vectors need to be generated and retained (stored or transmitted). The third view is generated using the decoded second view and a third set of data. A significant feature of the MLE CODEC encoder and storing data in the multiview format is that the decoded second view is used as one of the views in the fused data set. The decoded second view is similar to the previously described first view, in that the decoded second view is not exclusive, that is, the decoded second view does not exclude information that is also associated with elements of the third set of data. The third view is generated by combining the decoded second view and a third set of data, such that the third view contains information associated with elements of the third set of data other than elements of the third set of data that are in common with corresponding elements of the decoded second view, except for optional padding. Similar to the second view in the first fused data set, the third view contains information associated with elements of the third set of data that are not in common with corresponding elements of the decoded second view, except for optional padding. The second set of associated generating-vectors indicates operations to be performed on the elements of the decoded second view and third views to recover the second2) and third sets of data.

The above description is for three sets of data. If more than three sets of data are to be encoded, the method is repeated similar to the step of generating the second fused data set. In the context of this document, when referring to more than one fused data set, the terminology of “higher-level” and “lower-level” is used. In general, the term higher-level refers to a subsequently encoded or decoded fused data set, while the term lower level refers to a previously encoded (or decoded) fused data set. In a case where the original images are numbered 1, 2 . . . N for reference during encoding, (or as generated when decoding), the lowest level image encoded (decoded) is referred to as level 1, the next image encoded (or decoded) is 2, and so forth. For example, encoding a third image uses the lower-level second image (decoded second image) to generate a third-level fused data set. Decoding a fourth image comes from using the previous, lower-level fused data set, a third-level fused data set to generate the decoded fourth level image.

In general, the above-described method for generating multiview fused data can be repeated to generate a higher-level fused data set, the higher-level fused data set including a higher-level decoded view from a lower-level fused data set. Based on the above description, one skilled in the art will be able to expand the currently described method for multiview MLE encoding for an arbitrary number of sets of data. As a related example, refer back to the above description of the MLE CODEC for a description using five original images.

During or after generation of all or portions of the fused data sets, portions of the fused data sets are stored. A significant feature of the multiview format, and corresponding MLE CODEC, is that only portions of the fused data format are that needed for decoding need to be retained. Retaining includes, but is not limited to storing the retained data in a non-volatile memory, or in temporary storage. Temporary storage includes data that is generated for transmission, even if the data will not be retained by the generating system after transmission of the data. In general, the entire first fused data set is retained, including the first view, second view, and first set of generating-vectors. For the second and additional data sets, as one of the views (for example a left view) can be generated by the previous level's decoding, only the other view (for example a right view) and another set of generating-vectors needs to be retained.

Temporary storage during encoding includes portions of the fused data format that are not retained. In particular, after generation of a first fused data set, decoded views are generated for use in generating the next level fused data set. The decoded views are not necessary for decoding the multiple views from the stored and/or transmitted data. Depending on the specific application, storage of additional data may be desired. One example is storing additional data during encoding or decoding to improve processing. Another example is storing one or more decoded views during testing, or periodically during operation to verify the operation, processing, and/or quality of the CODEC.

MLE Decoder Based on the LRO Format

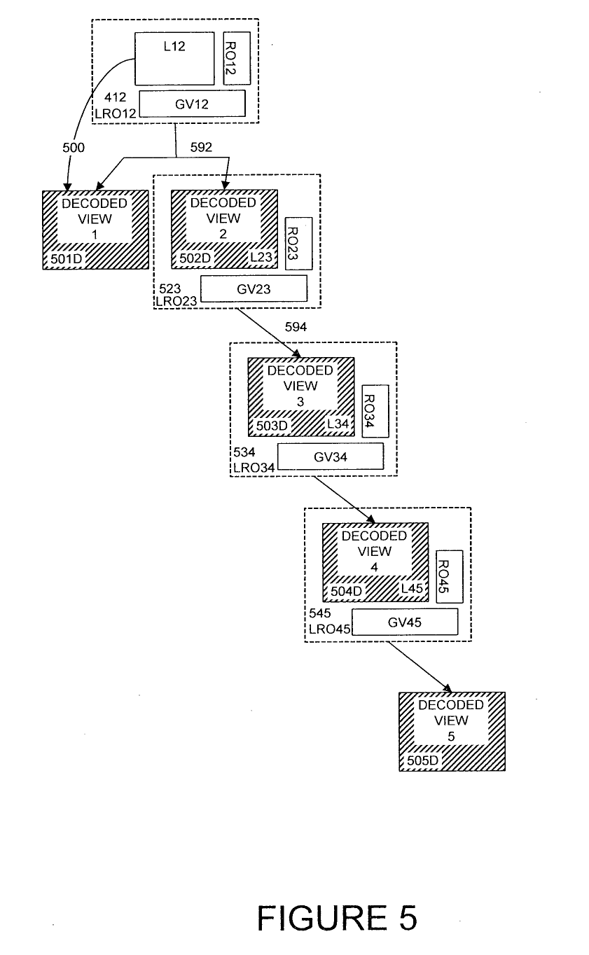

Referring to FIG. 5, a flow diagram of processing for an MLE CODEC decoder based on the LRO format, the non-limiting example of FIG. 4 is continued. In the context of this document, the MLE CODEC decoder is also referred to as simply the MLE decoder. Based on this description, one skilled in the art will be able to extend this decoding method to an arbitrary number of views, including more views and fewer views.

LRO12 fused data format (412) includes transmitted data L12, RO12, and GV12. LRO12 is decoded to generated decoded view 1 (501D) and decoded view 2 (502D). This decoding is similar to the decoding described above in reference to the LRO format for S3D. As described above, in general decoded view <N> is substantially the same as original view <N>.

Note that as decoded view 1 (501D) can be extracted from LRO12 as the L12 part. An alternative drawing could represent item 501D as being extracted from LRO12 via arrow 500, and item 501D not being striped. For consistency, the striped notation for all decoded views is maintained in the figures.

LRO23 (523) is decoded to generate decoded view 3 (503D). The format for LRO23 contains a left view L23, a right occlusions view RO23, and generating-vectors GV23. A significant feature of the method of this decoding is that decoded view 2 (502D) is used for left view L23. Since decoded view 2 (502D) is used for left view L23, the MLE CODEC decoder does not have to receive L23 as part of the data transmission. As described above, since L23 is not needed by the decoder, L23 is not produced or transmitted as part of LRO23. RO23 and GV23 are transmitted as part of the multiview transmission to the decoder. RO23 and GV23 are used with the generated decoded view 2 (502D), which is L23, to form LRO23. LRO23 is then decoded to generate decoded view 3 (503D).

After generating decoded view 3 (503D), the method repeats, using decoded view 3 (503D) as left view L34 of LRO34 (534). Data received by the MLE CODEC decoder for right occlusions view RO34 and generating-vectors GV34 completes the LRO34 fused data format. LRO34 is then decoded to generate decoded view 4 (504D).

Similarly, after generating decoded view 4 (504D), the method repeats, using decoded view 4 (504D) as left view L45 of LRO45 (545). Data received by the MLE CODEC decoder for right occlusions view RO45 and generating-vectors GV45 completes the LRO45 fused data format. LRO45 is then decoded to generate decoded view 5 (505D).

Note that the MLE CODEC decoder is a subset of the MLE CODEC encoder. As such, savings can be achieved in hardware and/or software implementation by a careful re-use of modules, specifically by implementing the encoder to allow for dual-use as a decoder.

In general, the first step of a method for decoding the multiview (fused data) format is similar to the above-described method for decoding an LRO fused data format. In a case where the encoded data are two-dimensional (2D) images, the general method for decoding data can be used for decoding 2D images. To avoid confusion between the similar terms “fused data sets” and “data sets” in the below description, data sets are referred to as 2D images. Generating data in the multiview format can be done by an MLE CODEC decoder.

A first fused data set includes a first view, a second view, and a first set of associated generating-vectors. The first and second views contain information associated with elements of a first 2D image and a second 2D image such that the first view contains information associated with elements of the first 2D image, and the second view contains information associated with elements of the second 2D image other than elements of the second 2D image that are in common with corresponding elements of the first 2D image, except for optional padding pixels. The first set of associated generating-vectors indicates operations to be performed on elements of the first and second views to render the first and second 2D images.

At least a decoded second view is rendered from the first fused data set using the first fused data set. The decoded second view is substantially the same as the second 2D image. Typically, a decoded first view is also rendered using the first fused data set. The decoded first view is substantially the same as the first 2D image.

A third view and a second set of associated generating-vectors are provided, which in combination with the decoded second view are used to render a decoded third view. The decoded second view, third view, and second set of associated generating-vectors are portions of a second fused data set. As the decoded second view, has been rendered from the previously provided first fused data set, only the third view and a second set of associated generating-vectors need to be provided to generate the decoded third view. The third view contains information associated with elements of a third 2D image other than elements of the third 2D image that are in common with corresponding elements of the second 2D image, except for optional padding pixels. The second set of associated generating-vectors indicates operations to be performed on elements of the decoded second view and the third view to render the decoded third view. The decoded third view is substantially the same as the third 2D image.

In general, the above-described method for decoding multiview fused data can be repeated to decode a higher-level fused data set, the higher-level fused data set including a higher-level decoded view from a lower-level fused data set. Based on the above description, one skilled in the art will be able to expand the currently described method for multiview MLE decoding for an arbitrary number of sets of data. As a related example, refer back to the above description of the MLE CODEC for a description using five original images.

MLE Encoder Based on the RLO Format

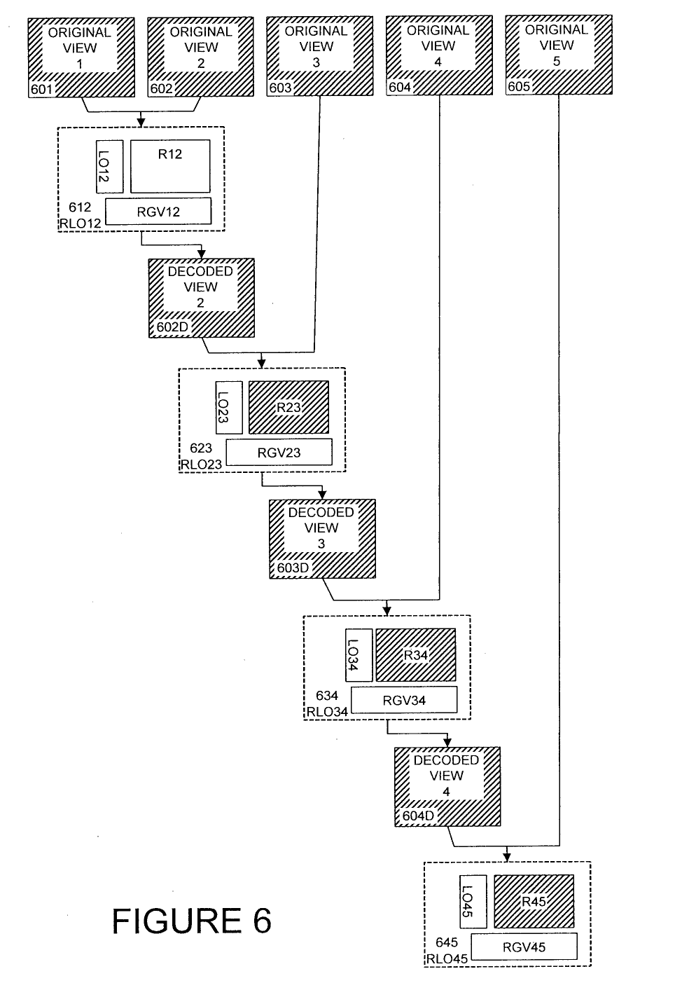

Referring to FIG. 6, a flow diagram of processing for an MLE CODEC encoder based on the RLO format, a non-limiting example of 5 views is encoded. The current example of an RLO encoder is similar to the above-described non-limiting example of an LRO encoder. 5 original views, original view 1 (601), original view 2 (602), original view 3 (603), original view 4 (604), and original view 5 (605), are encoded to produce a smaller amount of data, as compared to the amount of data in the original views. Original view 1 (601) and original view 2 (602) are used to generate RLO format for views 1 and 2 RLO12 (612), similar to the above described method for S3D with original view 1 (601) used as the left view and original view 2 (602) used as the right view. RLO12 contains a right view R12 [the part built from the right (R) and both (B) pixels], a left occlusions view LO12 [the part built from the left (L) pixels], and generating-vectors RGV12 (generating-vectors to regenerate the original left and right views). For clarity, references to the generating-vectors of the LRO format are of the form <GVnn>, while generating-vectors of the RLO format are of the form <RGVnn>. Note that similar to the preferred embodiment described above in reference to the LRO format, as all of the pixels for the original view 2 (602) are in the right view (R12) and only pixels for original view 1 (601) are in the left occlusions view (LO12), except for optional padding, so an alternative notation could be used in which R12 is R1 and LO12 is L2. However, for consistency and compatibility, the R12 and LO12 notation is maintained in this document.

R12, LO12, and RGV12 will all be required by the MLE CODEC decoder, so are part of the produced data, and fully contribute to a bit rate and bandwidth required for transmission. The original views (in this case original view 1 (601) and original view 2 (602) do not need to be transmitted. For clarity in the figures, items that do not need to be transmitted are striped, while items to be transmitted are not filled-in.

After generating R12, R12 is decoded to generate decoded view 2 (602D). While theoretically decoded view 2 (602D) can be the same as original view 2 (602), depending on the application and encoding parameters chosen, decoded view 2 (602D) and original view 2 (602) may be more or less similar. In other words, the quality of decoded view 2 (602D) as compared to original view 2 (602) may be substantially the same, or a lower quality. In general, the two views, decoded view 2 (602D) and original view 2 (602) are substantially the same, meaning that for a given application the differences between the two views are below a given threshold.

Decoded view 2 (602D) and original view 3 (603) are used to generate RLO format RLO23 623, similar to the above described method for RLO12. RLO23 contains a right view R23, a left occlusions view LO23, and generating-vectors RGV23. A significant feature of the method of this encoding is that decoded view 2 (602D) is used for right view R23. R23, LO23, and RGV23 will all be required by the MLE CODEC decoder. However, since decoded view 2 (602D) is used for right view R23, right view R23 does not have to be part of the produced data for RLO23. Fused view RLO12 is already transmitted, and can be used by the MLE CODEC decoder to produce decoded view 2 (602D) which can be used as the R23 part of RLO23. Hence, from RLO23, only the LO23 and RGV23 parts need to be transmitted. RLO23 does not fully contribute to the bit rate and bandwidth required for transmission, as R23 does not need to be transmitted. This contributes significantly to the bandwidth savings.

Note that in addition to only needing to transmit one of the two views (only LO23), since the non-transmitted view (R23) contains the right (R) and both (B) pixels, the view that is transmitted (LO23) contains only the left occlusion (LO) pixels and optional padding pixels, which is generally a smaller amount of data than the view not-transmitted (R23).

After generating RLO23, the method repeats, decoding RLO23 to generate decoded view 3 (603D). Decoded view 3 (603D) is substantially the same as original view 3 (603). Decoded view 3 (603D) and original view 4 (604) are used to generate RLO format RLO34 634, similar to the above described method for RLO12. RLO34 contains a right view R34, a left occlusions view LO34, and generating-vectors RGV34. Similar to the description in reference to right view R23, decoded view 3 (603D) is used for right view R34. R34, LO34, and RGV34 will all be required by the MLE CODEC decoder. However, since decoded view 3 (603D) is used for right view R34, right view R34 does not have to be part of the produced data for RLO34. Data for fused view RLO23 is already available, and can be used by the MLE CODEC decoder to produce decoded view 3 (603D) which can be used as the R34 part of RLO34. Hence, from RLO34, only the LO34 and RGV34 parts need to be transmitted. RLO34 does not fully contribute to the bit rate and bandwidth required for transmission, as R34 does not need to be transmitted.

As noted above in reference to RLO23 in addition to only needing to transmit one of the two views (only LO34), since the non-transmitted view (R34) contains the right (R) and both (B) pixels, the view that is transmitted (LO34) contains only the left occlusion (LO) pixels and optional padding pixels, which is generally a smaller amount of data than the view not-transmitted (R34).

After generating RLO34, the method repeats as already described, decoding RLO34 to generate decoded view 4 (604D). Decoded view 4 (604D) is substantially the same as original view 4 (604). Decoded view 4 (604D) and original view 5 (605) are used to generate RLO format RLO45 645, similar to the above described method for RLO12. RLO45 contains a right view R45, a left occlusions view LO45, and generating-vectors RGV45. Similar to the description in reference to right view R23, decoded view 4 (604D) is used for right view R45. R45, LO45, and RGV45 will all be required by the MLE CODEC decoder. However, since decoded view 4 (604D) is used for right view R45, right view R45 does not have to be part of the produced data for RLO45. Fused view RLO34 is already transmitted, and can be used by the MLE CODEC decoder to produce decoded view 4 (604D) which can be used as the R45 part of RLO45. Hence, from RLO45, only the LO45 and RGV45 parts need to, be transmitted. RLO45 does not fully contribute to the bit rate and bandwidth required for transmission, as R45 does not need to be transmitted.

The original data for the current example includes 5 original views. The data produced by the encoder includes only one original view [original view 1 (601)], right view R12 and four additional left views, LO12, LO23, LO34, and LO45 and correspondingly only four sets of generating-vectors RGV12, RGV23, RGV34, and RGV45.

MLE Decoder Based on the RLO Format

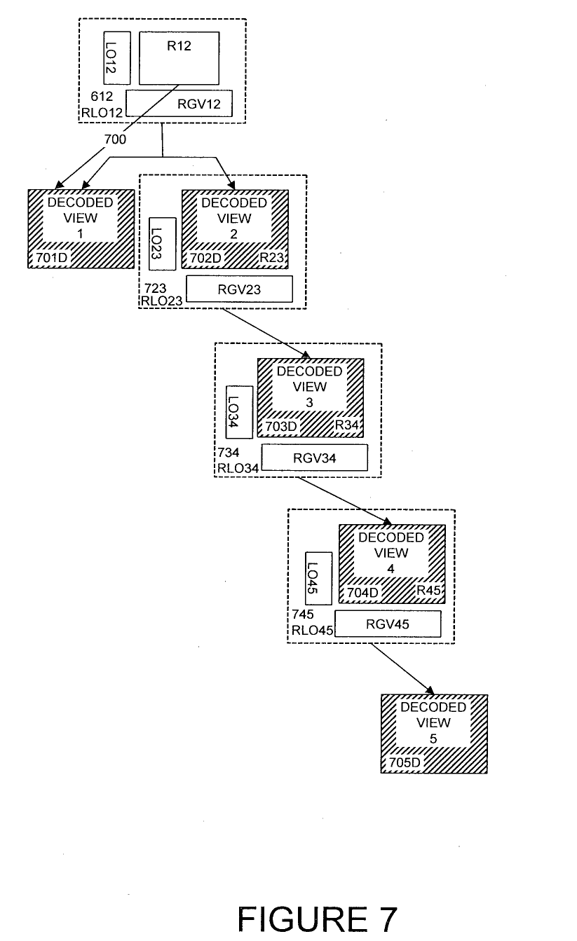

Referring to FIG. 7, a flow diagram of processing for an MLE CODEC decoder based on the RLO format, the non-limiting example of FIG. 6 is continued. The current example of an RLO decoder is similar to the above-described non-limiting example of an LRO decoder.

RLO12 fused data format (612) includes transmitted data R12, LO12, and RGV12. RLO12 is decoded to generated decoded view 1 (701D) and decoded view 2 (702D). This decoding is similar to the decoding described above in reference to the LRO format for S3D. As described above, in general decoded view <N> is substantially the same as original view <N>.

Note that as decoded view 1 (701D) can be extracted from RLO12 as the R12 part. An alternative drawing could represent item 701D as being extracted from RLO12 via arrow 700, and item 701D not being striped. For consistency, the striped notation for all decoded views is maintained in the figures.

RLO23 (723) is decoded to generate decoded view 3 (703D). The format for RLO23 contains a right view R23, a left occlusions view LO23, and generating-vectors RGV23. A significant feature of the method of this decoding is that decoded view 2 (702D) is used for right view R23. Since decoded view 2 (702D) is used for right view R23, the MLE CODEC decoder does not have to receive R23 as part of the data transmission. As described above, since R23 is not needed by the decoder, R23 is not produced or transmitted as part of RLO23. LO23 and RGV23 are transmitted as part of the multiview transmission to the decoder. LO23 and RGV23 are used with the generated decoded view 2 (702D), which is R23, to form. RLO23. RLO23 is then decoded to generate decoded view 3 (703D).

After generating decoded view 3 (703D), the method repeats, using decoded view 3 (703D) as right view R34 of RLO34 (734). Data received by the MLE CODEC decoder for left occlusions view LO34 and generating-vectors RGV34 completes the RLO34 fused data format. RLO34 is then decoded to generate decoded view 4 (704D).

Similarly, after generating decoded view 4 (704D), the method repeats, using decoded view 4 (704D) as right view R45 of RLO45 (745). Data received by the MLE CODEC decoder for left occlusions view LO45 and generating-vectors RGV45 completes the RLO45 fused data format. RLO45 is then decoded to generate decoded view 5 (705D).

Note that the MLE CODEC decoder is a subset of the MLE CODEC encoder. As such, savings can be achieved in hardware and/or software implementation by a careful re-use of modules, specifically by implementing the encoder to allow for dual-use as a decoder.

MLE CODEC Encoder Based on a Combination of the LRO and RLO Formats

Due to processing realities, including errors and/or artifacts appearing in a decoded view, the decoded views are normally substantially the same as the original images, but typically not exactly the same as the original images. The errors in the decoded views affect the quality of subsequent decoded views. In the above-described MLE encoders based on only either the LRO format or RLO format, there is typically a decrease in the quality of the decoded images as the CODEC progresses from lower to higher levels. A greater number of processing levels may have a greater decrease in the quality of the decoded image for higher levels, as compared to the original image.

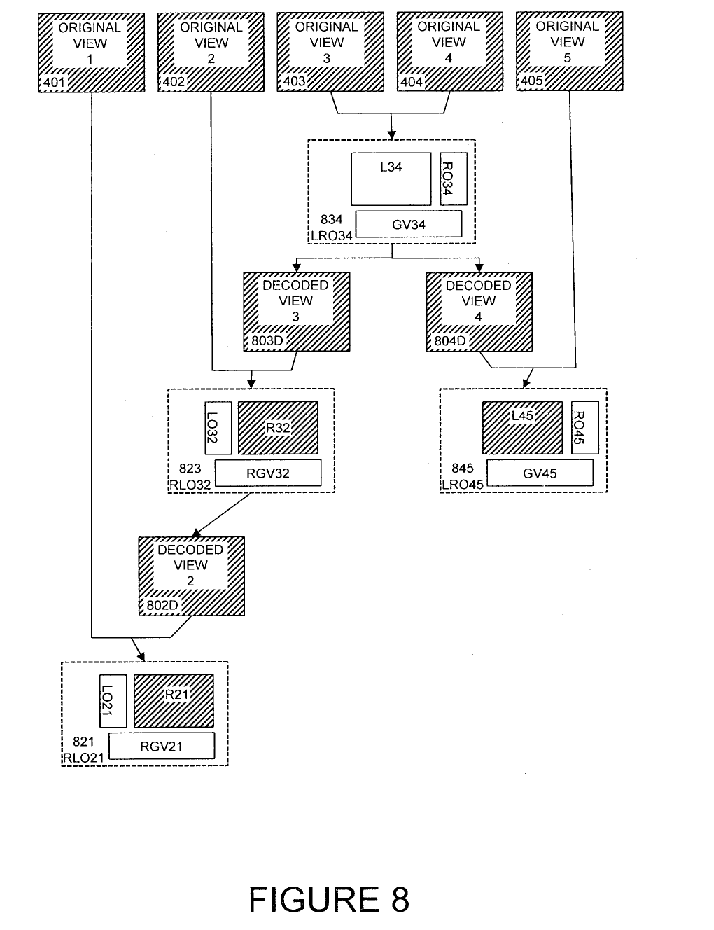

Variations of the MLE CODEC can be specified using a combination or mixture of LRO and RLO formats. Using a combination of formats can reduce the number of processing levels required to encode a given number of original images, thereby increasing the quality of the decoded images. Referring to FIG. 8, a flow diagram of processing for an MLE CODEC encoder based on a combination of the LRO and RLO formats, a non-limiting example of 5 views is encoded. While the LRO format CODEC described in reference to FIG. 4 has four processing levels (to generate LRO12, LRO23, LRO34, LRO45), the combination CODEC described below in reference to FIG. 8 has only two processing levels on the LRO pipeline branch (to generate LRO34 and LRO45) and three processing levels (to generate LRO34, RLO32, and RLO21) on the branch for the RLO pipeline. Note that in this case, the root of both the LRO and RLO branches is the same (LRO34), and only has to be generated once. Due to fewer processing levels in a branch when using a combination of formats, the resulting quality of decoded images can be better than the quality of decoded images when using a single format.

One skilled in the art will realize that processing of the LRO and RLO branches of processing levels can be implemented in parallel, serial, or a combination of processing order. Depending on the application, more than one root and more than two branches can also be used. In the below description, the LRO branch will first be described.

The current example of a combination MLE CODEC using LRO and RLO encoder is similar to the above-described non-limiting examples of LRO and RLO encoders. Based on this description, one skilled in the art will be able to extend this encoding method to an arbitrary number of views, including more views and fewer views, starting with a view appropriate for a specific application. 5 original views, original view 1 (401), original view 2 (402), original view 3 (403), original view 4 (404), and original view 5 (405), are encoded to produce a smaller amount of data, as compared to the amount of data in the original views. Original view 3 (403) and original view 4 (404) are used to generate LRO format for views 3 and 4 LRO34 834, similar to the above described method for S3D with original view 3 (403) used as the left view and original view 4 (404) used as the right view. LRO34 contains a left view L34 [the part built from the left (L) and both (B) pixels], a right occlusions view RO34 [the part built from the right (R) pixels and optional padding pixels], and generating-vectors GV34 (generating-vectors to regenerate the original left and right views). Note that in the preferred embodiment described above in reference to the LRO format, as all of the pixels for the original view 3 (403) are in the left view (L34) and only pixels for original view 4 (404) are in the right occlusions view (RO34).

L34, RO34, and GV34 will all be required by the MLE CODEC decoder, so are part of the produced data, and fully contribute to a bit rate and bandwidth required for transmission. The original views (in this case original view 3 (403) and original view 4 (404) do not need to be transmitted. For clarity in the figures, items that do not need to be transmitted are striped, while items to be transmitted are not filled-in.

After generating LRO34, LRO34 is decoded to generate decoded view 4 (804D) and decoded view 3 (803D). While theoretically decoded view 4 (804D) and decoded view 3 (803D) can be the same as original view 4 (404) and original view 3 (403), respectively, depending on the application and encoding parameters chosen, the decoded and respective original views may be more or less similar.

Decoded view 4 (804D) and original view 5 (405) are used to generate LRO format LRO45 (845), similar to the above described method for LRO34. LRO45 contains a left view L45, a right occlusions view RO45, and generating-vectors GV45. A significant feature of the method of this encoding is that decoded view 4 (804D) is used for left view L45. L45, RO45, and GV45 will all be required by the MLE CODEC decoder. However, since decoded view 4 (804D) is used for left view L45, left view L45 does not have to be part of the produced data for LRO45. Fused view LRO34 is already transmitted, and can be used by the MLE CODEC decoder to produce decoded view 4 (804D) which can be used as the L45 part of LRO45. Hence, from LRO45, only the RO45 and GV45 parts need to be transmitted. LRO45 does not fully contribute to the bit rate and bandwidth required for transmission, as L45 does not need to be transmitted. This contributes significantly to the bandwidth savings.

Note that in addition to only needing to transmit one of the two views (only RO45), since the non-transmitted view (L45) contains the left (L) and both (B) pixels, the view that is transmitted (RO45) contains only the right occluded (RO) pixels and optional padding pixels, which is generally a smaller amount of data than the view not-transmitted (L45).

Decoded view 3 (803D) and original view 2 (402) are used to generate RLO format RLO32 823, similar to the above described method for RLO 12. RLO32 contains a right view R32, a left occlusions view LO32, and generating-vectors RGV32. A significant feature of the method of this encoding is that decoded view 3 (803D) is used for right view R32. R32, LO32, and RGV32 will all be required by the MLE CODEC decoder. However, since decoded view 3 (803D) is used for right view R32, right view R32 does not have to be part of the produced data for RLO32. Fused view LRO34 is already transmitted, and can be used by the MLE CODEC decoder to produce decoded view 3 (803D) which can be used as the R32 part of RLO32. Hence, from RLO32, only the LO32 and RGV32 parts need to be transmitted. RLO32 does not fully contribute to the bit rate and bandwidth required for transmission, as R32 does not need to be transmitted. This contributes significantly to the bandwidth savings.

After generating RLO32 (823), the method repeats, decoding RLO32 to generate decoded view 2 (802D). Decoded view 2 (802D) is substantially the same as original view 2 (402). Decoded view 2 (802D) and original view 1 (401) are used to generate RLO format RLO21 (821), similar to the above described method for RLO32. RLO21 contains a right view R21, a left occlusions view LO21, and generating-vectors RGV21. Similar to the description in reference to right view R32, decoded view 2 (802D) is used for right view R21. R21, LO21, and RGV21 will all be required by the MLE CODEC decoder. However, since decoded view 2 (802D) is used for right view R21, right view R21 does not have to be part of the produced data for RLO21. Data for fused view RLO32 is already available, and can be used by the MLE CODEC decoder to produce decoded view 2 (802D) which can be used as the R21 part of RLO21. Hence, from RLO21, only the LO21 and RGV21 parts need to be transmitted. RLO21 does not fully contribute to the bit rate and bandwidth required for transmission, as R21 does not need to be transmitted.

MLE CODEC Decoder Based on a Combination of the LRO and RLO Formats

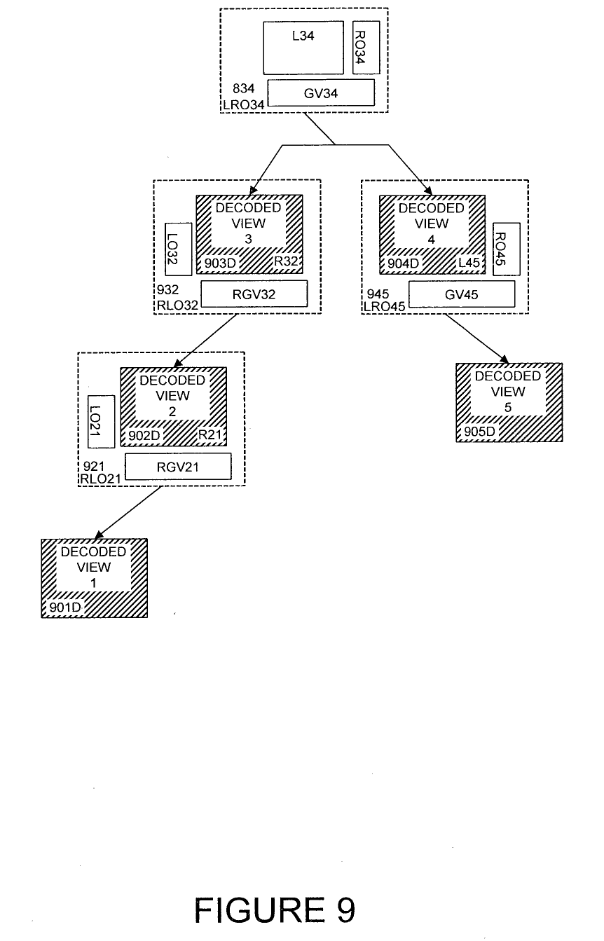

Referring to FIG. 9, a flow diagram of processing for an MLE CODEC decoder based on a combination of the LRO and RLO formats, the non-limiting example of FIG. 8 is continued. When decoding the combination format, the MLE CODEC decoder does not have to decode all branches. Only branches necessary for providing the desired images need to be decoded. In a non-limiting example, if a user wants to see what is happening in the direction of original image 3 (403), 4 (404), and 5 (405), only the left branch (LRO encoded data) needs to be decoded to provide the desired images.

LRO34 fused data format (834) includes transmitted data L34, RO34, and GV34. LRO34 is decoded to generated decoded view 4 (904D) and decoded view 3 (903D). This decoding is similar to the decoding described above in reference to the LRO format for S3D. As described above, in general decoded view <N> is substantially the same as original view <N>.

LRO45 (945) is decoded to generate decoded view 5 (905D). The format for LRO45 contains a left view L45, a right occlusions view RO45, and generating-vectors GV45. A significant feature of the method of this decoding is that decoded view 4 (904D) is used for left view L45. Since decoded view 4 (904D) is used for left view L45, the MLE CODEC decoder does not have to receive L45 as part of the data transmission. As described above, since L45 is not needed by the decoder, L45 is not produced or transmitted as part of LRO45. RO45 and GV45 are transmitted as part of the multiview transmission to the decoder. RO45 and GV45 are used with the generated decoded view 4 (904D), which is L45, to form LRO45. LRO45 is then decoded to generate decoded view 5 (905D).

For the right branch (RLO) pipeline of the combination MLE CODEC decoder, LRO34 fused data format (834) has already been decoded to generate decoded view 3 (903D). Additional data for the left occlusions view LO32 and generating-vectors RGV32 is received with the combination format data, along with decoded view 3 (903D as the R32 portion of RLO32 (932). A significant feature of the method of this decoding is that decoded view 3 (903D) is used for right view R32. Since decoded view 3 (903D) is used for right view R32, the MLE CODEC decoder does not have to receive R32 as part of the data transmission. As described above, since R32 is not needed by the decoder, R32 is not produced or transmitted as part of RLO32. LO32 and RGV32 are transmitted as part of the multiview transmission to the decoder. LO32 and RGV32 are used with the generated decoded view 3 (903D), which is R32, to form RLO32. RLO32 is then decoded to generate decoded view 2 (902D).

After generating decoded view 2 (902D), the method repeats, using decoded view 2 (902D) as right view R21 of RLO21 (921). Data received by the MLE CODEC decoder for left occlusions view LO21 and generating-vectors RGV21 completes the RLO21 fused data format. RLO21 is then decoded to generate decoded view 1 (901D).

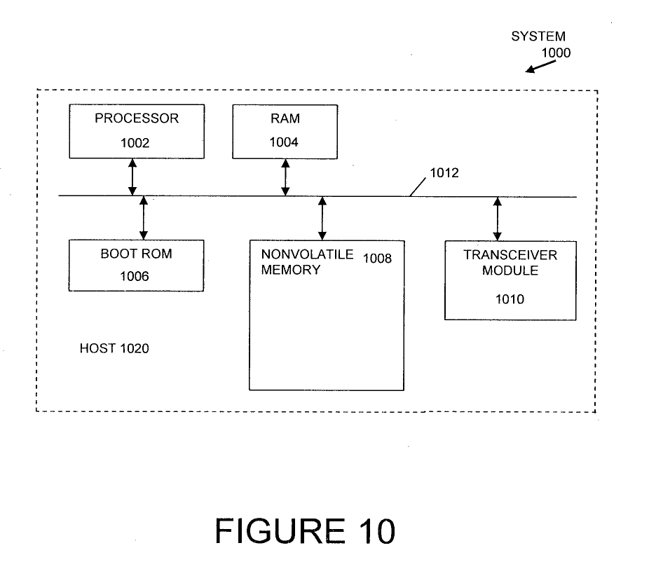

Referring to FIG. 10, a diagram of a system for LRO and MULTIVIEW encoding and decoding, this system can also be used for LRO and MULTIVIEW decoding. System 1000 includes a variety of processing modules, depending on the specific encoding and/or decoding required by the application. The high-level block diagram of a system 1000 of the present embodiment includes a processor 1002, a transceiver module 1010, and optional memory devices: a RAM 1004, a boot ROM 1006, and a nonvolatile memory 1008, all communicating via a common bus 1012. Typically, the components of system 1000 are deployed in a host 1020.

Transceiver module 1010 can be configured to receive and/or send data for encoding and/or decoding. When the transceiver module is used to receive data, the transceiver module functions as a data-receiving module.

For clarity, a limited number of elements from the accompanying figures are referenced in the current description. Based on this description, one skilled in the art will realize to which other elements are being referred, and will be able to extend this description for implementation with a specific application. Referring back to FIG. 3 and FIG. 4, received data for LRO encoding can include a first set of data (original view 1, 401) and a second set of data (original view 2, 402). Referring back to FIG. 5, received data for LRO decoding can include a first view (L12) and a second view (RO12), and generating-vectors (GV12) associated with the first and second views. Referring back to FIG. 4, in the case where the system 1000 is configured for multiview CODEC, received data for encoding can include first set of data (original view 1, 401), a second set of data (original view 2, 402), and a third set of data (original view 3, 403). Referring back to FIG. 5, received data for multiview decoding can include first fused data set (LRO12) a third view (RO23) and a second set of associated generating-vectors (GV23).

The results of LRO and multiview encoding and decoding can be transmitted via transceiver module 1010, stored in volatile memory, such as RAM 1004, and/or stored in nonvolatile memory 1008. RAM 1004 and nonvolatile memory 1008 can be configured as a storage module for data. Stored or transmitted data from LRO encoding includes the LRO fused view of FIG. 3A, the RLO fused view of FIG. 3B, and the (LRO12) fused view 412 of FIG. 4 (which includes first view L12, second view RO12, and associated generating-vectors GV12). Data from LRO decoding includes first set of data (decoded view 1, 501D) and second set of data (decoded view 2, 502D). Referring again to FIG. 4, data from multiview encoding includes first fused data set (LRO12 that is 412), third view (RO23), and second set of associated generating-vectors (GV23). Referring again to FIG. 5, data from multiview decoding includes a decoded first view (501D), a decoded second view (502D), and a decoded third view (503D). Obviously, data can be received or transmitted as two sets of data in a single file, as two or more files, or other configurations as appropriate to the application.

Nonvolatile memory 1008 is an example of a computer-readable storage medium bearing computer-readable code for implementing the data encoding and decoding methodologies described in the current document. Other examples of such computer-readable storage media include read-only memories such as CDs bearing such code.

The computer-readable code can include program code for one or more of the following: encoding data in the LRO format, decoding data from the LRO format, encoding data in the multiview format, and decoding data from the multiview format.

In FIGS. 4 to 9, arrows between data generally represent processing modules, or processing which can be implemented on a processing system that includes one or more processors such as processor 1002. For clarity in the diagrams, not all of the arrows are labeled. The following is an exemplary description and mapping of some of the LRO and multiview CODEC processing modules: In FIG. 4, arrow 490 represents a processing module, typically implemented as processing on a processor, such as processor 1002. Arrow 490, also referred to in this description as processing module 490, is an encoding process, which generates a fused view (LRO12/412) from two sets of data (original view 1, 401 and original view 2, 402). As described above, the fused view encoding process, arrow 490, is similar for LRO encoding or as a step in multiview encoding. Arrow 492, also referred to in this description as processing module 492, is a decoding process, which generates one or more decoded views, such as decoded view 2 (402D) from a fused view (LRO12/412) As described above, the fused view decoding process, arrow 492, is similar for LRO decoding or as a step in multiview decoding.

In FIG. 5, arrow 592, also referred to in this description as processing module 592, is a decoding process, which generates one or more decoded views, such as decoded view 1 (501D) and decoded view 2 (502D) from a fused view (LRO12/412). As described above, the fused view decoding process, arrow 592, is similar for LRO decoding or as a step in multiview decoding.

As will be obvious to one skilled in the art, the decoding processes arrow 492 and arrow 592 are similar, and the same processing module can be used for each. As such, the MLE CODEC decoder processing, (arrow 492) is a subset of the processing needed for the MLE CODEC encoder processing (including arrow 490 and arrow 492). As such, savings can be achieved in hardware, firmware, and/or software implementation by a careful re-use of modules, specifically by implementing the encoder to allow for dual-use of the decoding processing that is part of the encoder portion of the CODEC to be used for the decoding processing needed for the decoder portion of the CODEC.

To continue the current example for further clarity, refer again to FIG. 5. Arrow 594, also referred to in this description as processing module 594, is a decoding process, which generates one or more decoded views, such as decoded view 3 (503D). While processing module 594 can also generate decoded view 2 (502D), this is not necessary, as decoded view 2 (502D) already has been generated as part of the previous level's processing. The decoding process of arrow 594 is similar to arrow 592 and arrow 492, and is preferably implemented as the same processing module.

In general, in cases where the input data, including sets of data, original images, and fused data sets, are encoded, the encoding can be removed prior to processing. Encoded input data includes encoding in H.254, MPEG4, or any other format, as applicable for the application. Processing includes LRO encoding, LRO decoding, multiview encoding, and multiview decoding. The output data, including sets of data, and decoded views can be encoded in H.254, MPEG4, or any other format, as applicable for the application.

Note that a variety of implementations for modules and processing are possible, depending on the application. Modules can be implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

The use of simplified calculations to assist in the description of this embodiment should not detract from the utility and basic advantages of the invention.

It should be noted that the above-described examples, numbers used, and exemplary calculations are to assist in the description of this embodiment. Inadvertent typographical and mathematical errors should not detract from the utility and basic advantages of the invention.

It will be appreciated that the above descriptions are intended only to serve as examples, and that many other embodiments are possible within the scope of the present invention as defined in the appended claims.

What is claimed is:

1-42. (canceled)

43. A method for encoding data comprising the steps of:
(a) generating a first fused data set including a first view, a second view, and a first set of associated generating-vectors,
wherein said first and second views are generated by combining a first set of data and a second set of data, such that
(i) said first view contains the first set of data;
(ii) said second view contains information associated with elements of the second set of data other than elements of the second set of data that are in common with corresponding elements of the first set of data, and
wherein said first set of associated generating-vectors indicate operations to be performed on the elements of said first and second views to recover the first and second sets of data, said operations including only copying and occluding operations.

44. The method of claim 43 further including the steps of:
(b) generating a decoded second view using said first fused data set, said decoded second view substantially the same as the second set of data; and
(c) generating a third view, and a second set of associated generating-vectors wherein said third view is generated by combining said decoded second view and a third set of data, such that said third view contains information associated with elements of the third set of data other than elements of the third set of data that are in common with corresponding elements of said decoded second view, and said second set of associated generating-vectors indicate operations to be performed on the elements of said decoded second view and third views to recover the second and third sets of data.

45. The method of claim 43 wherein said first view includes elements that are common to the first and second sets of data.

46. The method of claim 43 wherein said second view only contains information associated with elements of the second set of data other than elements of the second set of data that are in common with corresponding elements of the first set of data.

47. The method of claim 43 wherein said second view contains additional information, said additional information other than information only associated with elements of the second set of data other than elements of the second set of data that are in common with corresponding elements of the first set of data.

48. The method of claim 44 wherein steps (b) to (c) are repeated to generate a higher-level fused data set, said higher-level fused data set including a higher-level decoded view from a lower-level fused data set.

49. The method of claim 43 wherein said second view includes elements of the first and second sets of data that are only in the second set of data.

50. The method of claim 43 wherein said first set of data is a first two-dimensional (2D) image of a scene from a first viewing angle, and said second set of data is a second 2D image of the scene from a second viewing angle.

51. A method for decoding data comprising the steps of:
(a) receiving a first fused data set including a first view, a second view, and a first set of associated generating-vectors, said first and second views containing information associated with elements of a first set of data and a second set of data such that:
(i) said first view contains the first set of data; and
(ii) said second view contains information associated with elements of the second set of data other than elements of the second set of data that are in common with corresponding elements of the first set of data, and
wherein said first set of associated generating-vectors indicating operations to be performed on elements of said first and second views to render the first and second set of data, said operations including only copying and occluding operations; and
(b) generating at least a decoded second view using said first fused data set, said decoded second view substantially the same as the second set of data.

52. The method of claim 51 further including the step of:
(c) generating a decoded third view using a second fused data set, said second fused data set including said decoded second view, a third view and a second set of associated generating-vectors, wherein said third view contains information associated with elements of a third set of data other than elements of the third set of data that are in common with corresponding elements of the second set of data, said second set of associated generating-vectors indicating operations to be performed on elements of said decoded second view and said third view to render said decoded third view, said decoded third view substantially the same as said third set of data.

53. The method of claim 51 wherein said first view includes elements that are common to the first and second sets of data.

54. The method of claim 51 wherein said second view only contains information associated with elements of the second set of data other than elements of the second set of data that are in common with corresponding elements of the first set of data.

55. The method of claim 51 wherein said second view contains additional information, said additional information other than information only associated with elements of the second set of data other than elements of the second set of data that are in common with corresponding elements of the first set of data.

56. The method of claim 51 further comprising the step of:
(d) generating, using said first view, said second view, and said generating-vectors, said second set of data.

57. The method of claim 51 wherein said first set of data is a first two-dimensional (2D) image of a scene from a first viewing angle, and said second set of data is a second 2D image of the scene from a second viewing angle.

58. The method of claim 51 wherein steps (b) to (c) are repeated to generate a higher-level fused data set, said higher-level fused data set including a higher-level decoded view from a lower-level fused data set.

59. The method of claim 52 wherein step (c) of generating is repeated to generate a higher-level decoded view using a higher-level fused data set, said higher-level fused data set including a decoded view from a lower-level fused data set.

60. The method of claim 51 further comprising the step of:
(d) generating a decoded first view using said first fused data set, said decoded first view substantially the same as the first set of data.
